(19) United States
(12) Patent Application Publication
(10) Pub. No.: US 2010/0114333 A1
(43) Pub. Date: May 6, 2010

(54) COMMUNICATION CONTROL APPARATUS AND COMMUNICATION CONTROL METHOD

(75) Inventor: Takao Otokozawa, Shizuoka (JP)

Correspondence Address: YOUNG & THOMPSON, 209 Madison Street, Suite 500, Alexandria, VA, 22314, US

(73) Assignee: FUJIFILM CORPORATION, TOKYO (JP)

(21) Appl. No.: 12/593,793

(22) PCT Filed: Mar. 24, 2008
(86) PCT No.: PCT/JP2008/056252

§ 371 Date: Sep. 29, 2009

(30) Foreign Application Priority Data
Mar. 29, 2007 (JP) 2007-088699

(51) Int. Cl. G05B 19/05; G06F 15/16

(52) U.S. Cl. 700/3; 709/230

(57) ABSTRACT

When a read command is sent from a command device to a communication control apparatus, a communication program refers to a PLC address table and cites a PLC address, including a communication protocol of the PLC identified by the read command. The communication program translates the read command using a protocol translation table and transmits the translated read command to the PLC. The communication program translates data read from the PLC using the protocol translation table, and stores the translated data in a tag file.

### TECHNICAL FIELD

The present invention relates to a communication control apparatus and a communication control method for transmitting and receiving data between a command device and a PLC (Programmable Logic Controller).

### BACKGROUND ART

There are production systems in which a production management apparatus transmits command data to a PLC (Programmable Logic Controller) for performing various process control modes on production facilities. The production facilities employ a wide variety of controllable devices, and often include PLCs of different manufacturers for controlling the controllable devices.

A PLC provided by each manufacturer has a dedicated Ethernet unit connectable to achieve an easy physical link connection to a production management apparatus, which is connected to a local area network (LAN). In order for the production management apparatus to actually transmit processing data to and receive processing data from the PLC, it is necessary to generate a communication program for each PLC based on a dedicated communication protocol provided by the PLC manufacturer. Generation of such a communication program requires a programmer having professional knowledge in the communications field.

According to the related art disclosed in Japanese Laid-Open Patent Publication No. 2000-341357, a communication program is generated with certain logical addresses assigned to respective PLCs, and is converted using a conversion table in which logical addresses are used as an argument, for thereby automatically generating the communication program based on the communication protocol for a certain PLC.

For generating communication programs for respective PLCs, the user is required to know the logical addresses assigned to the PLCs. When a PLC is changed or added, therefore, the user requires new information about the PLC. Since the user has to generate the communication program while being aware of the type of PLC used, the programming process may not be fully facilitated.

### DISCLOSURE OF INVENTION

It is a general object of the present invention to provide a communication control apparatus and a communication control method, which are capable of being programmed without the need for professional knowledge in the communications field, and also without having to be aware of the type of PLC connected to the network. Further, the communication control apparatus and the communication control method can easily contend with added or changed PLCs.

A major object of the present invention is to provide a communication control apparatus and a communication control method, which are capable of easily constructing a system including PLCs operated under different communication protocols.

Another object of the present invention is to provide a communication control apparatus and a communication control method, which can be programmed independently of certain platforms and hardware configurations.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF DRAWINGS

FIG. 1 is a diagram showing a format of command data in a communication program;

FIG. 2 is a diagram showing a format of response data in the communication program;

FIG. 3 is a block diagram of a system including a communication control apparatus;

FIG. 4 is a flowchart of a processing sequence for reading data from a PLC; and

FIG. 5 is a flowchart of a processing sequence for writing data in a PLC.

### BEST MODE FOR CARRYING OUT THE INVENTION

According to the communication protocol for a PLC provided by each PLC manufacturer, a certain command (read/write command) is transmitted to an Ethernet unit on the PLC using a TCP or UDP socket so as to access a data memory, which can be shared by a ladder program of the PLC.

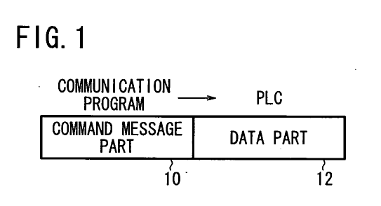

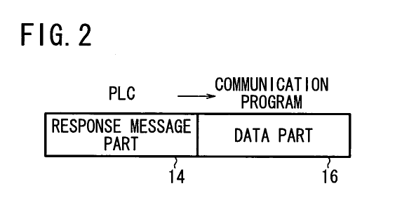

As shown in FIG. 1, a communication message transmitted to the PLC comprises a command message part 10 and a data part 12, which may be added if necessary. As shown in FIG. 2, a communication message transmitted from the PLC comprises a response message part 14 and a data part 16, which may be added if necessary. The formats of these communication programs are identical regardless of the type of PLC used, except for the detailed data structures thereof.

The command message part 10 represents information for commanding the reading of data in a designated number of channels, or for commanding the writing of data in a designated number of channels, from a first memory address of the designated PLC number. If the command transmitted to the PLC is a write command, then the command message part 10, together with the data part 12 added thereto, is transmitted to the PLC.

The response message part 14 represents response information transmitted from the PLC in response to commands transmitted thereto, and includes communication results information. If the response from the PLC is a response to a read command, then the response message part 14, with the data part 16 added thereto, is returned from the PLC.

The data part 12 or 16 stores data to be written or data that has been read. The data part 12 or 16 comprises as many data strings as the designated number of channels. The items of information included in the data part 12 or 16 depend on the use of data by the PLC, as well as the sequence by which data is generated by the PLC.

For standardizing the above communication programs regardless of the PLCs used, the following requirements must be met:

(1) The contents of the command message part 10, which include Ethernet communication conditions and different information makeups, can be identified based on the “destination PLC name” and “communication contents”.

(2) Accurate communication results can be extracted from the response message part 14, which include different information makeups.

(3) The items of information included in the data part 12 or 16 can easily be grasped.

In order to meet requirements (1) through (3), the following information tables and information files are prepared:

(1-1) Based on the “destination PLC name”, a PLC address table, which is an information table citing the IP address of the Ethernet unit on the PLC, the PLC address such as a socket number or the like, and the type of communication protocol, is prepared for each Ethernet unit on a PLC. The PLC address table is configured as shown in Table 1 below.

TABLE 1

| ITEM NAME | CONTENTS |
|---|---|
| PLC NAME | NAME FOR IDENTIFYING ETHERNET UNIT |
| | ON PLC |
| PLC IP ADDRESS | IP ADDRESS OF ETHERNET UNIT ON PLC |
| PLC PORT NO. | UDP PORT NO. ON ETHERNET UNIT ON PLC |
| MESSAGE TYPE | MESSAGE TYPE OF COMMAND/RESPONSE |
| PROTOCOL 1 | COMMUNICATION PROTOCOL NAME |
| NAME | |
| PROTOCOL 2 | PROTOCOL 2 OR PROTOCOL FOR EVENT- |
| NAME | DRIVEN PROCESSING |
| PLC VENDOR | NAME OF PLC MANUFACTURER |
| NAME | |

(1-2) Based on the “communication contents” (area name: tag name of a PLC data memory to be accessed), a protocol translation table, which is an information table citing command information according to the communication protocol transmitted to the PLC, is prepared. The protocol translation table is configured as shown in Table 2 below.

TABLE 2

| ITEM NAME | CONTENTS |
|---|---|
| PLC NAME | NAME FOR IDENTIFYING ETHERNET UNIT ON PLC |
| TAG NAME | RANGE ABBREVIATION GIVEN TO RANGE OF PLC DATA |
| | READABLE/WRITABLE IN ONE COMMUNICATION EVENT |
| COMMAND SOURCE | COMMAND MESSAGE SOURCE |
| TYPE OF | TYPE OF INFORMATION ON READING/WRITING PLC |
| INFORMATION | |
| COMMAND TYPE | READ (R)/WRITE (W) |
| COMMAND TEXT | CONTENTS OF COMMAND PART TRANSMITTED TO PLC OR |
| | RECEIVED FROM PLC |
| COMMUNICATION | RETURN CODE (OK RETURN VALUE) OF EXPECTED PLC |
| RESULTS VALUE | RESPONSE |
| START ADDRESS | FIRST ADDRESS OF READING/WRITING RANGE DESIGNATED |
| | BY TAG NAME |
| TAG SIZE | NUMBER OF CHANNELS IN READING/WRITING RANGE |
| | DESIGNATED BY TAG NAME |
| PROTOCOL NAME | COMMUNICATION PROTOCOL NAME OF PLC |

(2) An identification information table defining identification information for each protocol name used by a PLC is prepared. The identification information table is made up of a protocol master table (Table 3) indicating protocol-dependent information, a protocol header table (Table 4) indicating a protocol layout, and a protocol detail table (Table 5) indicating protocol identification information.

TABLE 3

| ITEM NAME | CONTENTS |
|---|---|
| VENDOR NAME | NAME OF PLC MANUFACTURER |
| PROTOCOL NAME | COMMUNICATION PROTOCOL NAME |
| | FOR PLC |
| COMMUNICATION | COMMUNICATION TYPE OF ETHERNET |
| TYPE | UNIT ON PLC |
| DATA REVERSE | REVERSE COMMAND IN DATA PART |
| MESSAGE END | ASCII END MARK OF COMMAND/ |
| MARK | RESPONSE MESSAGE |

TABLE 4

| ITEM NAME | CONTENTS |
|---|---|
| PROTOCOL NAME | COMMUNICATION PROTOCOL NAME OF PLC |
| HEADER TYPE | TYPE OF COMMAND/RESPONSE MESSAGE |
| HEADER TYPE CODE | HEX CHARACTER STRING FOR IDENTIFYING TYPE OF |
| | COMMAND/RESPONSE MESSAGE |
| HEADER TYPE CODE | POSITION OF HEADER TYPE CODE IN MESSAGE |
| POSITION | |
| HEADER TYPE CODE | LENGTH (BYTE LENGTH) OF HEADER TYPE CODE IN |
| LENGTH | MESSAGE |
| SEQUENCE NUMBER | POSITION OF SEQUENCE NUMBER IN MESSAGE |
| POSITION | |
| SEQUENCE NUMBER | LENGTH (BYTE LENGTH) OF SEQUENCE NUMBER IN |
| LENGTH | MESSAGE |

TABLE 5

| ITEM NAME | CONTENTS |
|---|---|
| PROTOCOL NAME | COMMUNICATION PROTOCOL NAME OF |
| | PLC |
| COMMAND TYPE | READ(R)/WRITE(W) |
| COMMAND LENGTH | LENGTH (BYTE LENGTH) OF COMMAND |
| | TEXT |
| RESPONSE LENGTH | LENGTH (BYTE LENGTH) OF RESPONSE |
| | TEXT |
| POSITION OF | POSITION OF COMMUNICATION |
| COMMUNICATION | RESULTS (RETURN CODE) IN |
| RESULTS | RESPONSE MESSAGE |
| COMMUNICATION | LENGTH (BYTE LENGTH) OF |
| RESULTS LENGTH | COMMUNICATION RESULTS IN |
| | RESPONSE MESSAGE |

(3) Based on the tag name (area name of a PLC data memory to be accessed), a tag file is prepared, which cites the relative address, the item length, and the data type (ASCII, BCD, BIN, HEX, or the like) of an item of information in the area, and further, which exchanges information of the data part 12 or 16 sorted by the items of information with a functional application for transmitting a communication request to a communication program. The tag file is configured as shown in Table 6 below.

TABLE 6

| ITEM NAME | CONTENTS |
|---|---|
| PLC NAME | NAME FOR IDENTIFYING ETHERNET UNIT ON |
| | PLC |
| TAG NAME | RANGE ABBREVIATION GIVEN TO RANGE |
| | OF PLC DATA READABLE/WRITABLE IN ONE |
| | COMMUNICATION EVENT |
| ITEM NAME | NAME OF EACH ITEM MAKING UP TAG |
| OFFSET VALUE | FIRST POSITION OF ITEM VALUE IN TAG |
| DATA TYPE | DATA TYPE OF ITEM VALUE |
| DATA LENGTH | LENGTH (FIGURES) OF DATA OF ITEM VALUE |
| REVERSING | METHOD OF PLACING INDICATED 5 FIGURES |
| METHOD | OR MORE |
| WORK AREA | DATA VALUE INDICATED BY ITEM NAME |

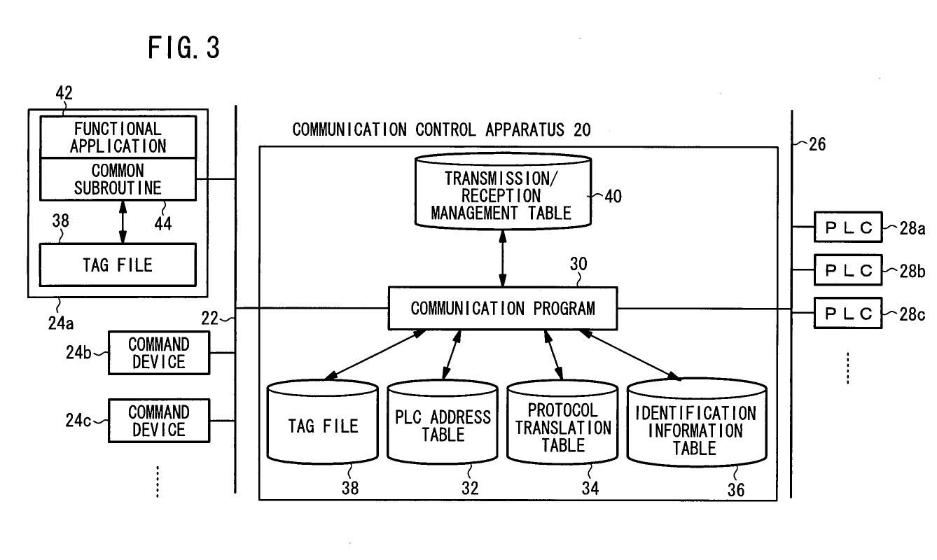

FIG. 3 shows in block form a system, which incorporates therein a communication control apparatus and a communication control method according to the present invention. As shown in FIG. 3, the system comprises a communication control apparatus 20 having the tables and files described above in items (1-1), (1-2), (2), and (3) above, a plurality of command devices 24a, 24b, 24c, . . . connected to the communication control apparatus 20 via a network 22, and a plurality of PLCs 28a, 28b, 28c, . . . connected to the communication control apparatus 20 via a network 26.

The communication control apparatus 20 transmits command information from command devices 24a, 24b, 24c, . . . to the PLCs 28a, 28b, 28c, . . . so as to control the controllable devices connected thereto. Also, the communication control apparatus 20 transmits operating information of the controllable devices from the PLCs 28a, 28b, 28c, . . . to the command devices 24a, 24b, 24c, . . . . The communication control apparatus 20 is independent of the command devices 24a, 24b, 24c, . . . and the PLCs 28a, 28b, 28c, . . . . Therefore, the communication control apparatus 20 may be configured so as not to depend on the hardware configurations and platforms of the command devices 24a, 24b, 24c, . . . .

The communication control apparatus 20 comprises a communication program 30, which performs a communication process to transmit and receive data via the networks 22, 26, a PLC address table 32, a protocol translation table 34, an identification information table 36, and a tag file 38, referred to above, for converting data depending on the types of PLCs 28a, 28b, 28c, . . . used therewith.

The communication control apparatus 20 also includes a transmission/reception management table 40 for managing the progressing status of respective communication requests from the command devices 24a, 24b, 24c, . . . . By using the transmission/reception management table 40, the communication control apparatus 20 can handle asynchronous communication requests from the command devices 24a, 24b, 24c, . . . . The transmission/reception management table 40 is configured as shown in Table 7 below.

TABLE 7

| ITEM NAME | CONTENTS |
|---|---|
| STATUS | STATUS FLAG FOR MANAGING PROGRESSING STATUS |
| | OF COMMUNICATIONS |
| SEQUENCE NO. | SEQUENCE NO. ADDED TO COMMAND MESSAGE FOR PLC |
| POSITION OF | POSITION OF COMMUNICATION RESULTS (RETURN |
| COMMUNICATION | CODE) IN RESPONSE MESSAGE |
| RESULTS | |
| COMMUNICATION | LENGTH (BYTES) OF COMMUNICATION RESULTS |
| RESULTS LENGTH | (RETURN CODE) IN RESPONSE MESSAGE |
| COMMUNICATION | RETURN CODE (RETURN VALUE) OF EXPECTED PLC |
| RESULTS | RESPONSE |
| PLC NAME | PLC NAME REQUESTED FOR COMMUNICATIONS BY |
| | REQUEST SOURCE FUNCTIONAL APPLICATION |
| TAG FILE NAME | TAG FILE NAME PREPARED BY REQUEST SOURCE |
| | FUNCTIONAL APPLICATION |
| TAG FILE PATH | PATH OF TAG FILE PREPARED BY REQUEST SOURCE |
| | FUNCTIONAL APPLICATION |
| TAG NAME | TAG NAME REQUESTED FOR COMMUNICATIONS BY |
| | REQUEST SOURCE FUNCTIONAL APPLICATION |
| COMMUNICATION | MODE REQUESTED FOR COMMUNICATIONS BY REQUEST |
| MODE | SOURCE FUNCTIONAL APPLICATION |
| HANDLE TYPE | DETAILED NO. OF CONTENTS OF REQUEST OF |
| | REQUEST SOURCE FUNCTIONAL APPLICATION |
| DATA REVERSE | REVERSE COMMAND IN DATA PART |
| RESPONSE LENGTH | LENGTH (BYTES) OF HEADER PART OF EXPECTED PLC |
| | RESPONSE |
| TAG LENGTH | LENGTH (BYTES) OF DATA PART OF EXPECTED PLC |
| | RESPONSE |
| REQUEST SOURCE | IP ADDRESS OF REQUEST SOURCE FUNCTIONAL |
| IP ADDRESS | APPLICATION |
| REQUEST SOURCE | UDP PORT NO. OF REQUEST SOURCE FUNCTIONAL |
| PORT NO. | APPLICATION |
| INITIAL TIMER | INITIAL VALUE FOR DETECTING TIME-OUT |
| VALUE | |
| CURRENT TIMER | TIMER VALUE FOR DETECTING TIME-OUT |
| VALUE | |

Each of the command devices 24a, 24b, 24c, . . . has a functional application 42 for controlling the controllable devices connected to the PLCs 28a, 28b, 28c, . . . , a common subroutine 44 according to the same description rules that does not depend on the PLCs 28a, 28b, 28c, . . . , for performing communications between the functional application 42 and the communication program 30, and a tag file 38. The tag file 38 is a file that is transferred via FTP, for example, between each of the command devices 24a, 24b, 24c, . . . and the communication control apparatus 20.

The common subroutine 44 is described in the C language, for example. Since the common subroutine 44 is described using a highly versatile programming language, each of the command devices 24a, 24b, 24c, . . . can exchange information with the PLCs 28a, 28b, 28c, . . . at the same level used for accessing general-purpose files, platform independently, and without being aware of any complex PLC communication scheme.

General-purpose communications using UDP sockets, which are easily handled, can be performed between the common subroutines 44 and the communication program 30, as well as between the communication program 30 and the PLCs 28a, 28b, 28c, . . . . Data to be written in the PLCs 28a, 28b, 28c, . . . and data read from the PLCs 28a, 28b, 28c, . . . are converted by the tag files 38, and exchanged between the common subroutines 44 and the communication program 30.

The communication control apparatus 20 processes data depending on dedicated protocols of the PLCs 28a, 28b, 28c, . . . based on the PLC address table 32, the protocol translation table 34, and the identification information table 36, which are separate from the communication program 30. Therefore, the communication control apparatus 20 can communicate with the PLCs 28a, 28b, 28c, . . . according to a process that does not depend on the protocols of the PLCs 28a, 28b, 28c, . . . . When a new PLC is added or when a PLC is changed, the PLC can be added or exchanged easily simply by adding a PLC address table 32, a protocol translation table 34, and an identification information table 36.

Processing sequences of the communication control apparatus 20 shall be described below.

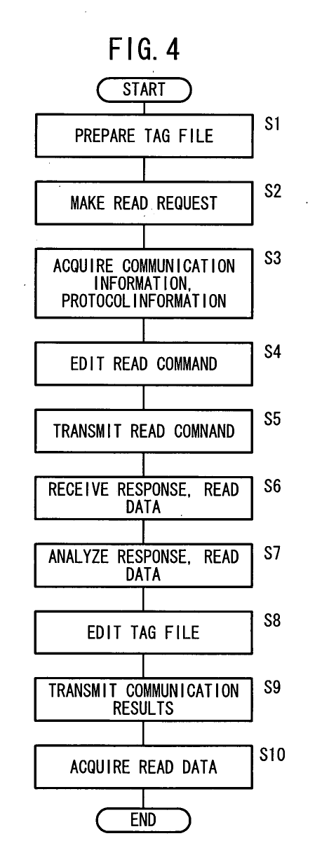

FIG. 4 is a flowchart of a processing sequence for reading data from the PLCs 28a, 28b, 28c, . . . .

First, in step S1, the functional application 42 of each of the command devices 24a, 24b, 24c, . . . calls the common subroutine 44 and prepares the tag file 38. Then, the functional application 42 calls the common subroutine 44 and transmits a read command designating a destination PLC name and communication contents (tag name) to the communication program 30, thereby making a read request in step S2.

In step S3, when the communication program 30 receives the read command, the communication program 30 specifies one of the PLCs 28a, 28b, 28c, . . . based on the destination PLC name, acquires communication information including a communication protocol from the PLC address table 32 shown in Table 1, and also acquires protocol information (read command) from the protocol translation table 34 shown in Table 2 and the identification information table 36 shown in Tables 3 through 5.

In step S4, the communication program 30 edits the read command transmitted from the command device into a read command compatible with the destination PLC, according to the communication information and the protocol information that have been acquired. Then, in step S5, the communication program 30 transmits the edited read command to the destination PLC. When the destination PLC receives the transmitted read command, the destination PLC transmits a response and read data to the communication program 30.

In step S7, when the communication program 30 receives the response and the read data from the destination PLC in step S6, the communication program 30 analyzes the response and the read data according to the communication information and the protocol information, which have been acquired in step S3. Thereafter, the communication program 30 edits the tag file 38 in step S8. Then, in step S9, the communication program 30 transmits communication results (ACK/NACK) to the functional application 42. In step S10, when the functional application 42 receives the communication results, the functional application 42 acquires the read data from the tag file 38.

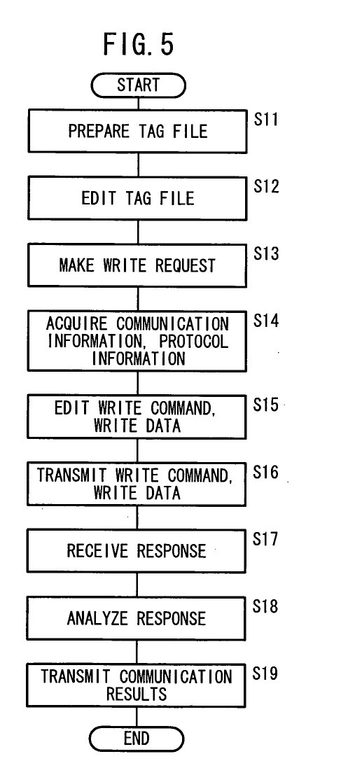

FIG. 5 is a flowchart of a processing sequence for writing data in the PLCs 28a, 28b, 28c, . . . .

First, in step S11, the functional application 42 of each of the command devices 24a, 24b, 24c, . . . calls the common subroutine 44 and prepares the tag file 38. Then, in step S12, the functional application 42 calls the common subroutine 44, and edits the value of each item of the tag file 38 according to write data. Thereafter, in step S13, the functional application 42 transmits a write command designating a destination PLC name and communication contents (tag name) to the communication program 30, thereby making a write request.

In step S14, when the communication program 30 receives the write command, the communication program 30 acquires communication information including a communication protocol from the PLC address table 32 shown in Table 1. The communication program 30 also acquires protocol information (write command) from the protocol translation table 34 shown in Table 2 and the identification information table 36 shown in Tables 3 through 5.

In step S15, the communication program 30 acquires write data from the tag file 38, and edits the write command transmitted from the command device into a read command and into write data compatible with the destination PLC, according to the communication information and the protocol information. Then, in step S16, the communication program 30 transmits the edited write command and write data to the destination PLC. When the destination PLC receives the transmitted write command and write data, the destination PLC controls the controllable device according to the write command and the write data, and transmits a response to the communication program 30.

In step S18, when the communication program 30 receives the response from the destination PLC in step S17, the communication program 30 analyzes the response according to the communication information and the protocol information, which have been acquired in step S14. Then, in step S19, the communication program 30 transmits communication results (ACK/NACK) to the functional application 42.

Even when write data are unilaterally transmitted from the PLCs 28a, 28b, 28c, . . . to the communication control apparatus 20 (event-driven communications), the communication control apparatus 20 can handle and collect the write data quickly, and without the need for any special programs.

Specifically, when write data together with a write command are transmitted from the PLCs 28a, 28b, 28c, . . . to the communication control apparatus 20, the communication program 30 analyzes the received write command and the write data using the protocol translation table 34, classifies the analyzed write data into pre-registered items, and outputs them to the tag file 38.

The command devices 24a, 24b, 24c, . . . easily make up a system for monitoring the tag file 38 with separate functional applications 42, so as to automatically store information concerning the PLCs 28a, 28b, 28c, . . . .

Next, an explanation shall be made of the high-rate communications performed by the communication control apparatus 20, and the manner in which the communication control apparatus 20 handles an unspecified number of communication requests and parties (PLCs) that communicate therewith.

The communication control apparatus 20 usually has a waiting time, ranging from several tens to approximately one hundred ms., after it has transmitted a command to a PLC and until it receives a response from the PLC. According to the general communication method, since the communication control apparatus 20 waits for a response during the waiting time, the communication control apparatus 20 does not process new communication requests received from the functional application 42 of any command device during the waiting time, but rather, holds any new communication requests unprocessed until the preceding communication event is finished. Therefore, the system suffers a communication delay. Such a communication delay is problematic when the communication program 30 simultaneously communicates with a plurality of PLCs, or communicates with a PLC that is compatible with full-duplex communications.

In the communication control apparatus 20 according to the present embodiment, the communication program 30 is arranged to incorporate a software-implemented interrupt function for UPD sockets, which asynchronously processes communication requests (commands) transmitted from the functional applications 42 of the command devices 24a, 24b, 24c, . . . , along with responses received from the PLCs 28a, 28b, 28c, . . . . In this manner, the communication control apparatus 20 is capable of performing high-rate communications free of communication delays caused by the waiting time for responses from the PLCs 28a, 28b, 28c, . . . .

Communication requests from the functional applications to the communication program 30 are transmitted as a number of requests from an unspecified plurality of sources, and are made at asynchronous timings. Therefore, it is necessary to manage the progressing status of respective communication requests, which are generated simultaneously, and to send accurate communication results to the functional applications.

In the communication control apparatus 20 according to the present embodiment, the transmission/reception management table 40 manages progressing statuses of respective communication requests from the functional applications 42 of the command devices 24a, 24b, 24c, . . . for identifying the functional applications 42 as communication request sources, thereby managing the progressing statuses (elapsed times) of communication requests, holding the transmission of commands to those of the PLCs 28a, 28b, 28c, . . . which lack full duplex communication capability, and transmitting responses to communication request sources.

When the communication program 30 receives a communication request from the functional application 42 of one of the command devices 24a, 24b, 24c, . . . , the communication program 30 registers information indicative of the reception of the communication request in the transmission/reception management table 40. When the communication program 30 receives a response from one of the PLCs 28a, 28b, 28c, . . . , the communication program 30 searches the transmission/reception management table 40 based on the corresponding PLC name obtained from the sequence number, the IP address, etc., included in the response information, and acquires the information of the request source. After having registered the progressing status in the transmission/reception management table 40, the communication program 30 decrements the current timer value every second, for example, and returns a response to the functional application 42 as the communication request source when the decremented current timer value becomes nil.

The communication control apparatus and the communication control method according to the present invention may be applied to a facility communication function in a production information system for managing and controlling production facilities, and to a location updating function in a warehouse management information system, for example. In the warehouse management information system, for example, a stacker crane controller indicates the ID of a material and a destination location to the communication program 30 each time the material is loaded, unloaded, or changes its storage rack. Based on the indicated information, the communication program 30 automatically generates a file (movement history file). The functional application 42 updates location information that is resident in a separate database based on the generated movement history file.

Although a certain preferred embodiment of the pre-sent invention has been shown and described in detail, it should be understood that various changes and modifications may be made therein without departing from the scope of the invention as set forth in the appended claims.

1. A communication control apparatus for transmitting and receiving data between a command device and a PLC (Programmable Logic Controller), comprising:
a PLC address table for citing a PLC address including a communication protocol of said PLC based on a communication destination PLC name transmitted from said command device, which identifies said PLC as a communication destination;
a protocol translation table for translating a command message part and a data part transmitted from said command device respectively into a command message part and a data part, which are compatible with the communication protocol of said PLC identified by said PLC address table;
an identification information table for defining identification information for acquiring communication results information from a response message part and a data part transmitted from said PLC; and
a tag file for exchanging said data parts added to said command message part and said response message part as required, with said command device.

2. A communication control apparatus according to claim 1, which is connected to a plurality of said PLCs having respective different communication protocols, wherein said PLC address table, said protocol translation table, and said identification information table are configured to handle said different communication protocols.

3. A communication control apparatus according to claim 1, which is connected to a plurality of said command devices, wherein said command devices transmit data to and receive data from said communication control apparatus through a common subroutine according to the same description rules.

4. A communication control apparatus according to claim 1, further comprising:
a transmission/reception management table for managing transmission/reception status of data depending on a communication request from said command device.

5. A communication control apparatus according to claim 1, wherein said identification information table comprises a protocol master table indicating protocol-dependent information, a protocol header table indicating a protocol layout, and a protocol detail table indicating protocol identification information.

6. A communication control apparatus according to claim 1, wherein said command device includes a functional application for controlling a controllable device connected to said PLC, and a common subroutine according to description rules not depending on said PLC, for performing communications between said functional application and a communication program of said communication control apparatus.

7. A communication control method for transmitting and receiving data between a command device and a PLC (Programmable Logic Controller), comprising the steps of:
citing a PLC address including a communication protocol of said PLC from a PLC address table based on a communication destination PLC name transmitted from said command device, and which identifies said PLC as a communication destination;
translating a command message part and a data part transmitted from said command device respectively into a command message part and a data part, which are compatible with the communication protocol cited from said PLC address table;
transmitting the command message part and the data part, which have been translated, to the PLC having the cited PLC address; and
acquiring communication results information from a response message part and a data part transmitted from said PLC, and exchanging said communication results information with said command device.
